(19) United States
(12) Patent Application Publication
(10) Pub. No.: US 2009/0059189 A1
(43) Pub. Date: Mar. 5, 2009

(54) PELLICLE FOR USE IN A MICROLITHOGRAPHIC EXPOSURE APPARATUS

(75) Inventors: Aksel Goehnermeier, Aalen (DE); Alexandra Pazidis, Aalen (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 11/994,747

(22) PCT Filed: Jun. 19, 2006
(86) PCT No.: PCT/EP06/05833

§ 371 Date: May 12, 2008

Related U.S. Application Data
(60) Provisional application No. 60/700,142, filed on Jul. 18, 2005.

(51) Int. Cl. G03B 27/52; F21V 9/06; G03B 27/72

(52) U.S. Cl. 355/30; 359/361; 355/71

(57) ABSTRACT

A pellicle for use in microlithographic exposure apparatus (10) has, for an operating wavelength of the apparatus, a maximum transmittance for light rays (56) that obliquely impinge on the pellicle (34; 134; 234). This ensures smaller variations of the transmittance over a broad range of angles of incidence, as it occurs in very high numerical aperture projection lenses.

### BACKGROUND OF THE INVENTION

1. Field of the Invention

The present invention relates to optical pellicles for preventing adhesion of dust or other particles to a mask used in a microlithographic exposure apparatus.

2. Description of Related Art

Microlithography, which is also referred to as photolithography, is a technology for the fabrication of integrated circuits, liquid crystal displays and other microstructured devices. More particularly, the process of microlithography, in conjunction with the process of etching, is used to pattern features in thin film stacks that have been formed on a substrate, for example a silicon wafer. At each layer of the fabrication, the wafer is first coated with a photoresist or another material that is sensitive to radiation, for example deep ultraviolet (DUV) light. Next, the wafer covered with the photoresist is exposed to projection light through a mask in a projection exposure apparatus. Amplitude masks contain a pattern of opaque structures that block transmission of a correspondingly patterned portion of the incident light. During projection of the mask, an inverse pattern of the mask pattern is imaged on the photoresist, usually at a reduced scale. After exposure, the photoresist is developed to produce an image corresponding to the pattern contained in the mask. Then an etch process transfers the circuit pattern into the thin film stacks on the wafer. Finally, the photoresist is removed. Repetition of this process with different masks results in a multi-layered microstructured component.

Accurate reproduction of the mask pattern on the photoresist is of paramount significance for the production of such microstructured components. Therefore, the integrity of the mask must be protected to allow repeated use. Small particles, such as airborne dust or fibers, are a significant source for degrading the accuracy of mask pattern reproduction. Even very small particles can alter light transmission when positioned near the focal plane of the mask. As a result, these particles can produce defects in the component to be produced.

To protect the integrity of the mask pattern, it is known to use an optical pellicle, which is often simply referred to as pellicle. A pellicle includes a thin membrane having a uniform thickness. Typically, the optical pellicle is supported above the mask surface by a frame. The membrane acts as a dust cover that is capable of keeping particles away from the surface of the mask. Instead, particles are collected on the pellicle surface, but remain at a distance from the mask that is determined by the height of the frame. Thus the particles are positioned relatively distant from the front focal plane (i.e. the mask plane) of the projection lens, and hence the ability of the particles to disturb the imaging of the mask pattern onto the photoresist is significantly mitigated.

Pellicles should not affect the transmitted light as such. This involves, in particular, that pellicles should have a very high transmittance and should not introduce distortions. To achieve a high transmittance, pellicles are generally constructed of a material that absorbs very little light at the light wavelength selected for the microlithographic process. Distortions are avoided by ensuring a very uniform thickness at a specific value between approximately 0.5 μm to 2 μm.

When sources that produce UV light of longer wavelengths are used in the projection exposure apparatus, nitrocellulose or cellulose acetate provides pellicle membranes with high transmittance, but an anti-reflective coating (“AR coating”) is required due to the relatively high refractive index of these materials. For shorter wavelengths in the deep ultraviolet (DUV) spectral range, such as 248 nm, 193 nm or 157 nm, membranes constructed from commercially available fluoropolymer resins have been used successfully. For example, the fluoropolymers CYTOP from Asahi Glass and AF-1600 from DuPont have been found to be suitable. Pellicles constructed with these fluoropolymers have a high transmittance for these wavelengths and have such a low refractive index that an AR coating could be dispensed of.

Nevertheless AR coatings are often applied to the membrane for various reasons. The most important motives are the improvement of the transmittance of the pellicle and the reduction of transmittance sensitivity to membrane thickness variations. Another object in the design of AR coatings may be to prevent transmittance variations as the wavelength changes.

For example, U.S. Pat. No. 5,741,576 A1 describes a pellicle comprising a membrane and an AR coating. The pellicle has a transmittance of at least 99% for a first wavelength range from 361 nm to 369 nm and also for a second wavelength range from 430 nm to 442 nm.

Suitable materials and production methods for applying AR coatings to membranes are disclosed in U.S. Pat. No. 5,674,624.

US 2002/0181092 A1 discloses a pellicle that is electrically conductive so as to achieve an antistatic effect.

Pellicles comprising coated membranes are also described in U.S. Pat. No. 4,657,805, U.S. Pat. No. 5,008,156, U.S. Pat. No. 4,759,990 and EP 0 488 788 A.

One approach to reduce the minimum feature size in microstructured components is based on the concept of introducing an immersion liquid into the interspace between the last lens element of the projection lens on the image side and the photoresist. This enables an increase of the image side numerical aperture (NAᵢ) of the projection lens to values larger than 1.

However, it has been discovered that using conventional pellicles in projection exposure apparatuses having an image side numerical aperture beyond 1 results in a degradation of the image quality.

### SUMMARY OF THE INVENTION

It is therefore an object of the present invention to provide a pellicle that is particularly suited for being used in a projection exposure apparatuses having an image side numerical aperture in excess of 1.

According to a first aspect of the invention, this object is achieved by a pellicle for use in a microlithographic exposure apparatus that has, for an operating wavelength of the microlithographic exposure apparatus, a transmittance maximum for light rays that impinge on the pellicle with angles of incidence between 2° and 25°.

The transmittance maximum may be local or global. The term “local transmittance maximum” refers to a maximum of the transmittance in the presence of a further maximum with a still larger transmittance inside or outside the specified range of angles. This situation may occur, for example, if a still larger transmittance is achieved for perpendicular incidence or at an angle of incidence larger than 25°.

The term “global” refers to the situation in which there is no other transmittance maximum at all, or in which there is a further maximum inside or outside the specified range of angles, but at this further maximum the transmittance is nevertheless smaller as compared with the global maximum.

This new approach deviates from the conventional design rule that assumes perpendicular incidence when attempting to achieve a transmittance maximum. According to this first aspect of the invention, the transmittance maximum usually obtained at perpendicular incidence is deliberately shifted towards oblique incidence. This is because projection lenses having a high image side numerical aperture NAᵢ also have a large object side numerical aperture NAₒ which is given by NAₒ=M·NAᵢ, where M is the magnification of the projection lens.

For example, if NAᵢ=1.4 and the magnification of the projection lens is M=¼, the object side numerical aperture is NAₒ=0.35. This corresponds to a maximum angle of about 20°. For comparison, a conventional projection lens that is not designed for immersion operation may have an image side numerical aperture of 0.8, with maximum angles at the object side of the projection lens of only 11.5°.

This considerable increase of the maximum angles occurring at the object side of the projection lens in immersion systems has the consequence that the light rays traversing the pellicle have larger angles of incidence as well. In conventional pellicles the transmittance maximum is achieved at perpendicular incidence, and the transmittance does not considerably decrease for angles of incidence up to about 12°. However, at larger angles of incidence the transmittance of the pellicle significantly drops to values below 98%. For an angle of incidence of 20°, for example, the transmittance may be as low as 90%. This dependence of the intensity on the angle of incidence contributes to the image degradations that have been observed in immersion projection lenses when being used with conventional pellicles.

According to the first aspect of the invention, however, the design objective of the pellicle is altered such that a local or global transmittance maximum is achieved at angles of incidence between 2° and 25°. As a result, the sharp drop of the transmittance is, so to say, shifted towards larger angles of incidence beyond the range of angles that actually occur at the object side of the projection lens. This, of course, also means that the transmittance for perpendicular incidence is reduced if compared with conventional pellicles. However, a good reproduction of the pattern contained in a mask on the wafer does not require maximum transmittance at a certain angle, but both a high mean transmittance on the one hand and a high minimum transmittance on the other. To be more specific, the pellicle should be designed such that the mean transmittance, for a given range of angles of incidence that is determined by the projection lens, is greater than 95% and preferably greater than 98%. The variations of the transmittance over this range should be, on the other hand, less than 5% and preferably less than 2.5%.

The range of angles of incidence is between 0° and arcsin(NAₒ) with NAₒ being the object side numerical aperture of the projection lens. In practice this may result in a range of angles of incidence between 0° and about 25° for projection lenses with a very high object side numerical aperture NAₒ. For smaller values of NAₒ, the range of angles of incidence may be smaller, for example between 0° and 15°. For particular illumination settings, there may be a non-continuous range of angles of incidence, for example between arcsin(NAₒ/2) and arcsin(NAₒ).

Computations and experiments have shown that a high mean transmittance and small transmittance variations may be achieved if the transmittance maximum is achieved for angles of incidence between 5° and 20° and preferably between 10° and 15°.

For achieving such an optical behavior the pellicle may be formed by a single membrane that is not covered by an anti-reflection coating. If the membrane is not covered by an anti-reflection coating so that it is in immediate contact with the surrounding gas, the optical properties of the pellicle, and in particular the dependence of the transmittance on the angle of incidence is solely determined by the refractive index of the membrane and its thickness. Using an uncoated membrane as a pellicle may be advantageous for cost reasons.

Certain optical properties of the pellicle may be improved if the pellicle comprises not only a membrane but also an anti-reflective coating applied to the membrane. Such a coating may comprise at least two layers and be applied to one or both sides of the membrane. The optical effect of the anti-reflective coating may be selectively determined in view of various optical properties. For example, the anti-reflective coating may be designed such that the transmittance maximum of the pellicle for light rays that obliquely impinge on the pellicle is achieved for different operating wavelengths. An antistatic effect, as is known in the art as such, may also be achieved. Furthermore, the outmost layer of the coating may be designed such that the adhesion of dust or other particles is reduced. This property may be achieved if the outmost layer contains an organic component.

In another advantageous embodiment the pellicle is designed such that its transmittance does not, as is the case in prior art pellicles, decrease, but continuously increases with increasing angles of incidence. Such a dependence may be advantageous, for example, if the projection exposure apparatus contains optical elements in a pupil plane that have a lower transmittance with growing distance from the optical axis, for example a thick biconcave lens. The pellicle may then be used for achieving a compensation of such generally undesired dependencies. If the projection lens is designed for immersion operation, the transmittance may increase with increasing angles of incidence in such a way that an absorption of oblique rays in the immersion liquid is substantially compensated for. Since the immersion liquid is in immediate vicinity to the back focal plane of the projection lens, angles of incidence at the pellicle directly translate into angles of incidence on the photoresist. Since the transmittance of known immersion liquids cannot be neglected, oblique rays travelling a longer distance in the immersion liquid suffer a stronger absorption than perpendicular rays. This effect can be compensated for by an opposite dependence of the transmittance in the pellicle.

If a still more homogenous angular intensity distribution is required, it may be considered to arrange an additional absorptive filter element in or in close proximity of a pupil plane of the projection lens. The filter element has a locally varying transmittance that may be determined such that the dependency of the transmittance of the pellicle on the angle of incidence is at least substantially compensated for. In the presence of an immersion liquid, the locally varying transmittance of the filter element may be determined such that both the dependency of the transmittance of the pellicle on the angle of incidence and also the dependency of the transmittance of the immersion liquid on a second angle of incidence with respect to the light sensitive layer are (at least substantially) commonly compensated for. Instead of or in addition to arranging such an absorptive filter element in or in close proximity of a pupil plane, an absorptive filter element with an angularly varying transmittance may be arranged in or in close proximity to a field plane, for example the mask plane, the wafer plane or an intermediate image plane.

According to a second aspect of the invention, the above stated object is achieved by a pellicle comprising a membrane and an anti-reflective coating applied to the membrane. The membrane and the anti-reflective coating are designed such that, for an operating wavelength of the microlithographic exposure apparatus, the transmittance of the pellicle varies by less than 2% for angles of incidence between 0° and 15°, more preferably between 0° and 25°. Even more preferably the transmittance varies by less than 1% in these angular ranges. This aspect of the invention is based on the discovery that it is possible, with a suitable design of anti-reflective coatings, to achieve a transmittance that is, for a large range of angles up to 15°, almost constant. The transmittance maximum may be as high as 98% or even 99.5%.

Consequently, there is no need for an additional absorptive filter in a pupil plane that may compensate for the dependency of the transmittance of the pellicle on the angle of incidence.

Having a transmittance that is almost independent of the angle of incidence over the required range of angles is often the favorable solution in view of imaging properties. However, the application of a plurality of thin layers on one or preferably on both sides of the membrane may involve a complicated and costly manufacturing process. Since pellicles have a restricted life time due to material degradations, costly pellicles may considerably increase the overall running costs of the projection exposure apparatus.

### BRIEF DESCRIPTION OF THE DRAWINGS

Various features and advantages of the present invention may be more readily understood with reference to the following detailed description taken in conjunction with the accompanying drawings in which:

FIG. 1 shows a meridional section through a projection exposure apparatus according to the invention in a highly simplified representation which is not to scale;

FIG. 2 is an enlarged sectional view of a pellicle used in the projection exposure apparatus of FIG. 1 according to a first embodiment of the invention;

FIG. 3 is a graph showing the angular dependence of the transmittance of the pellicle shown in FIG. 2;

FIG. 4 is an enlarged sectional view of a pellicle used in the projection exposure apparatus of FIG. 1 according to a second embodiment of the invention;

FIG. 5 is a graph showing the angular dependence of the transmittance of the pellicle shown in FIG. 4;

FIG. 6 is an enlarged sectional view of a pellicle used in the projection exposure apparatus of FIG. 1 according to a third embodiment of the invention;

FIG. 7 is a graph showing the angular dependence of the transmittance of the pellicle shown in FIG. 6;

FIG. 8 is a graph showing the angular dependence of the transmittance of a pellicle according to a fourth embodiment;

FIG. 9 is an enlarged sectional view of an end portion of a projection lens contained in the projection exposure apparatus of FIG. 1;

FIG. 10 is a top view on a absorptive filter element contained in the projection lens.

### DESCRIPTION OF PREFERRED EMBODIMENTS

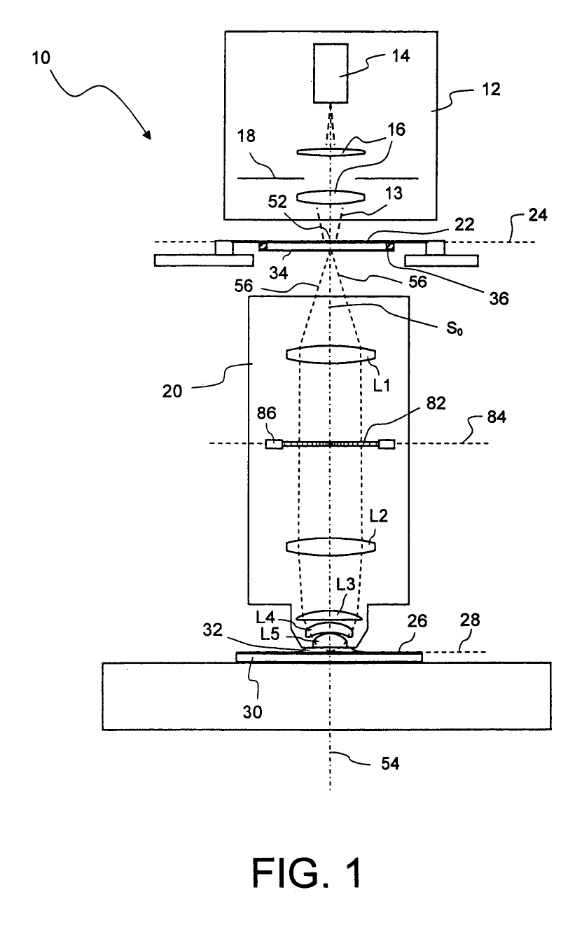

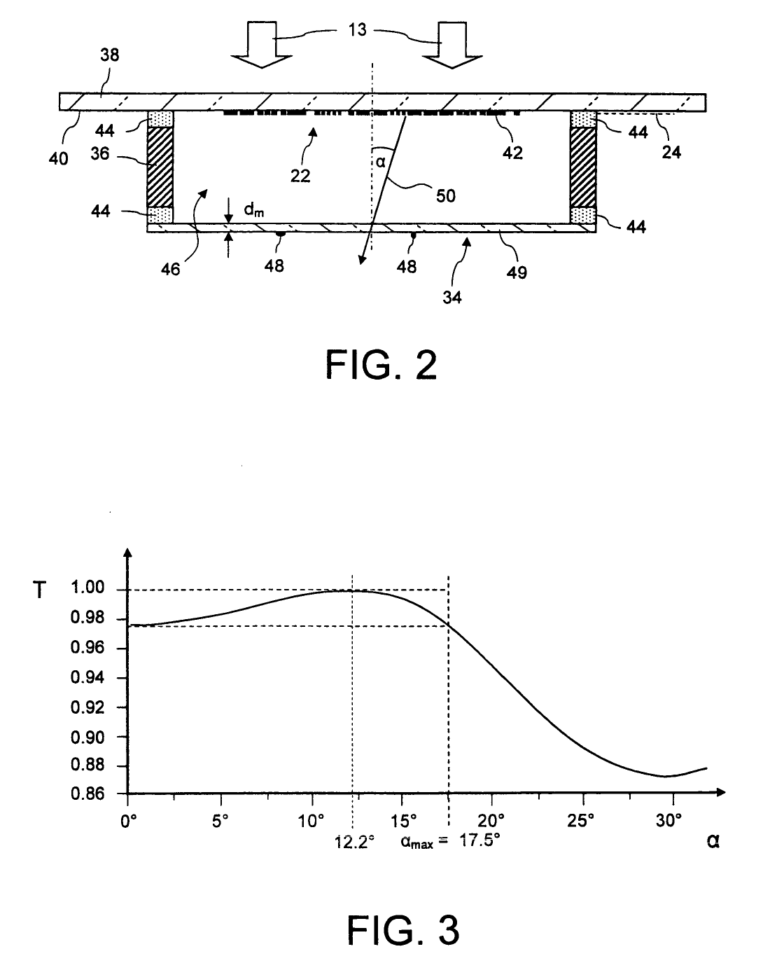

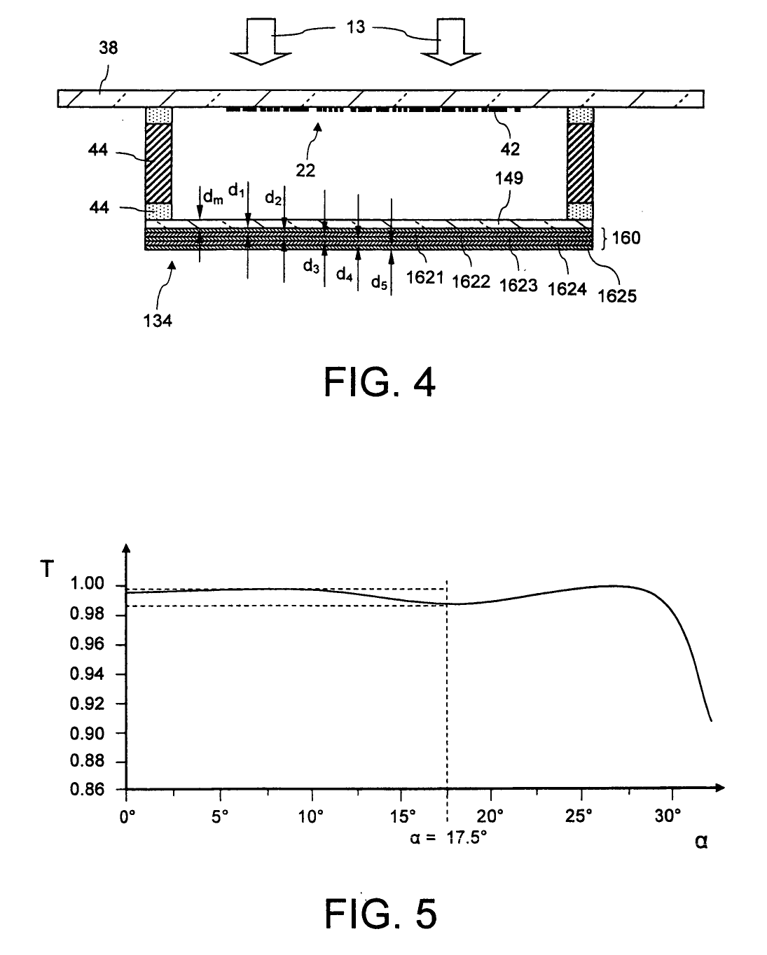

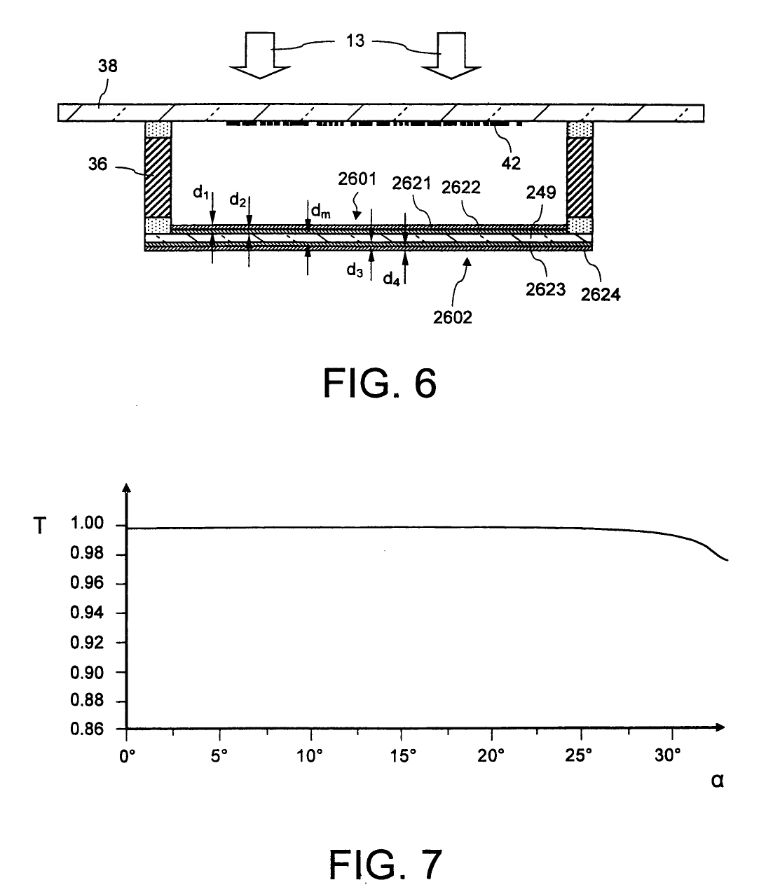

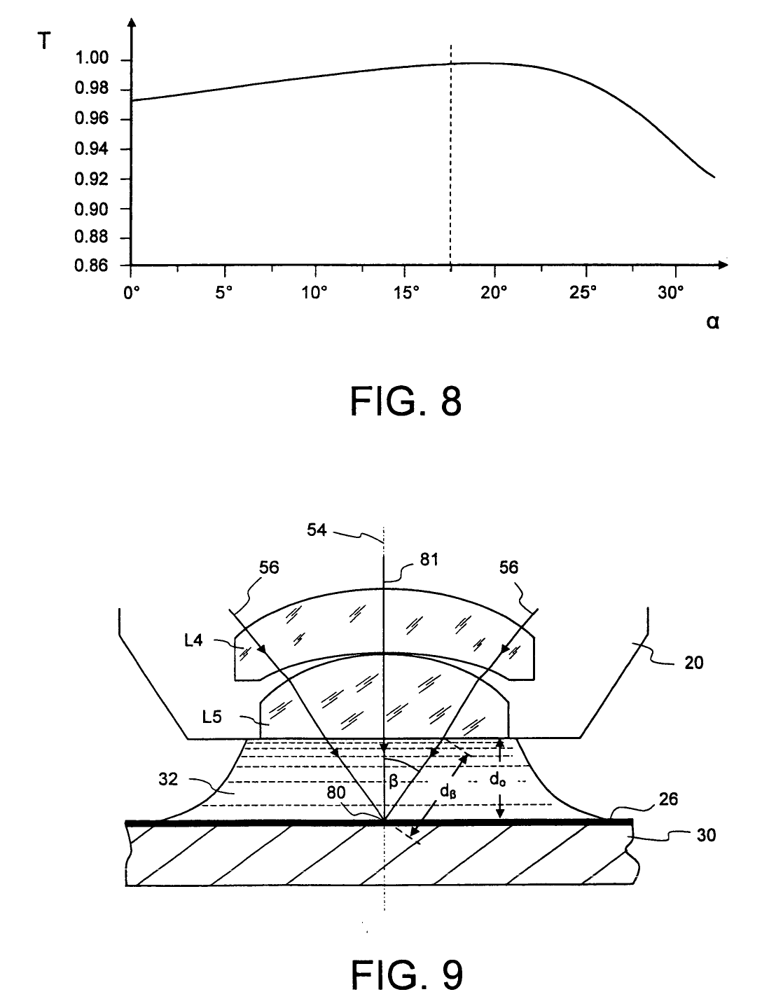

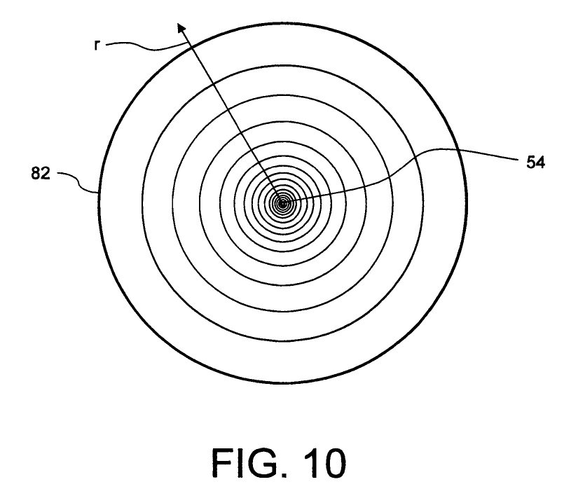

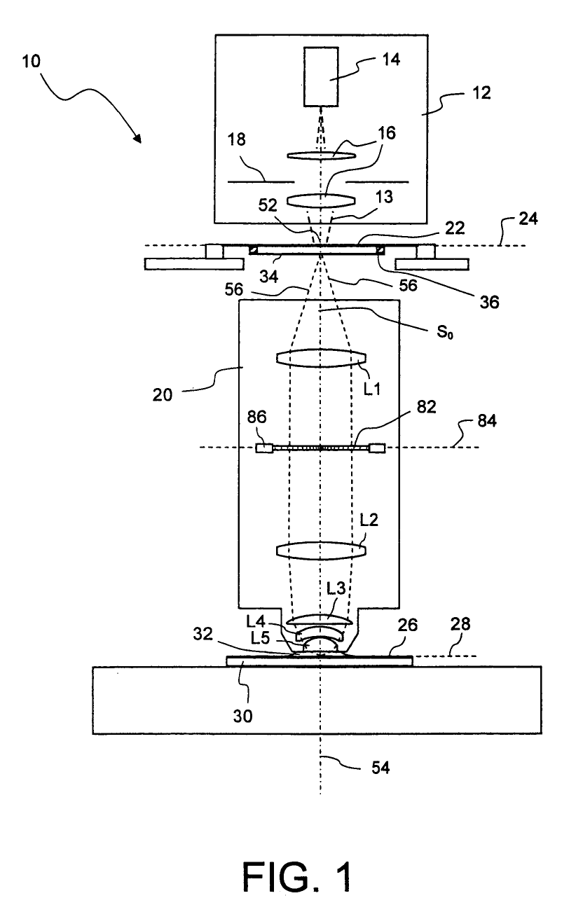

FIG. 1 shows a meridional section through a microlithographic projection exposure apparatus in a highly simplified representation. The projection exposure apparatus, which is denoted in its entirety by 10, includes an illumination system 12 for generating projection light 13. The illumination system 12 has a light source 14, illumination optics indicated by 16 and a diaphragm 18. In the exemplary embodiment, the projection light has a wavelength of 193 nm. Of course, other wavelengths such as 157 nm or 248 nm, are contemplated as well.

The projection exposure apparatus 10 further includes a projection lens 20 containing a multiplicity of lens elements. For the sake of simplicity, only very few lens elements L1 to L5 are schematically indicated in FIG. 1. The projection lens 20 is used to image a mask 22 arranged in an object plane 24 of the projection lens 20 on a photoresist 26. In this embodiment the projection lens 20 has a magnification M=¼ so that the pattern formed on the photoresist 26 is four times smaller than the pattern contained in the mask 20. The photoresist 26 is supported on a substrate 30 and precisely positioned in an image plane 28 of the projection lens 20.

An interspace formed between the photoresist 26 and the last lens element L5 of the projection lens 20 is filled with an immersion liquid 32. The refractive index of the immersion liquid 32, which may be water or an oil, for example, is preferably chosen such that it approximately coincides with the refractive index of the photoresist 26. Immersion operation makes it possible to design the projection lens 20 with an object side numerical aperture NAₒ>1. In the embodiment shown in FIG. 1 it is assumed that NAₒ=1.2. A high numerical aperture of the projection lens 20 reduces its resolution and thus enables smaller minimum feature sizes of the components to be manufactured.

The mask 22 is protected against dust and other particles by a pellicle 34 that is supported by a frame 36 above the patterned mask surface.

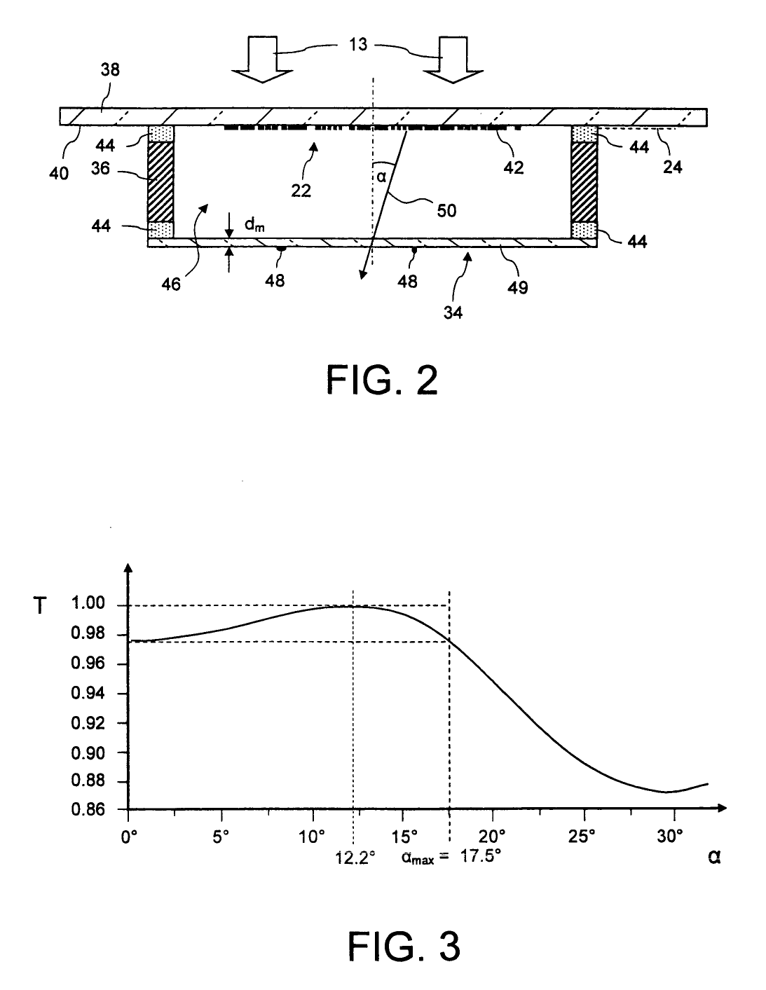

FIG. 2 shows the mask 22, the pellicle 34 and the frame 36 in an enlarged cross-section. The mask 22 comprises a mask substrate 38 that may be realized as a plate made of quartz glass. An underside 40 of the mask substrate 38 supports a patterned chrome layer 42 that is exactly positioned in the object plane 24 of the projection lens 20. Projection light 13 that impinges on a chrome structure is completely blocked, whereas projection light 13 passing through interspaces between adjacent chrome structures is diffracted into different orders of diffraction.

Adhesives 44 are used for attaching the pellicle 34 to the frame 36 and also to attach the frame 36 to the underside 40 of the mask substrate 38. The patterned chrome layer 42 is therefore received in a cavity that does not that no such particles may adhere to the patterned chrome layer 42 and be imaged onto the photoresist 26.

Although the projection exposure apparatus 10 is usually installed in a clean room, there may nevertheless be particles 48 having a significant size in the surrounding atmosphere. If such particles 48 adhere to the underside of pellicle 34, they are considerably outside the object plane 24 of the projection lens 20. As a result, such particles 48 are not imaged onto the photoresist 26. Although the particles 48 may block a portion of the projection light that has passed the patterned chrome layer 42, this will not have a noticeable adverse effect on the image quality.

In the embodiment shown in FIG. 2, the pellicle 34 consists of a thin membrane 49 and having a thickness dₘ of 740 nm and an index of refraction nₘ=1.45. For the operating wavelength λ=193 nm this ensures a very high transmittance that is very close to 100%.

FIG. 3 shows the transmittance T as a function of the angle of incidence α for light rays 50 that impinge on the pellicle 34. As can be seen from FIG. 3, the thickness dₘ of the membrane 49 and its material is determined in such a way that the transmittance T varies between 97.8% and 100% for angles of incidence between 0° (i.e. perpendicular incidence) and an angle αₘₐₓ=17.5°. The angle αₘₐₓ is the maximum angle that occurs on the object side of the projection lens 20. The angle αₘₐₓ is given by αₘₐₓ=arcsin(NAᵢ·M), where M is the magnification of the projection lens 20 and NAᵢ is the image side numerical aperture. With M=¼ and NAᵢ=1.2 in the embodiment shown, this yields αₘₐₓ=17.5°. Aperture rays emanating with αₘₐₓ from a mask point 52 centered on the optical axis 54 are denoted in FIG. 1 by 56.

The transmittance maximum Tₘₐₓ=99.9% is obtained for an angle of incidence of about 12.2°, i.e. for light rays that obliquely impinge on the pellicle 34. This is not an advantageous effect as such, but it ensures that the variations of the transmittance T are, for all possible angles of incidence α, very small, namely less than about 2%. In most cases such variations of the transmittance T for different angles of incidence can be tolerated and do not significantly deteriorate the image quality.

Even smaller variations of the transmittance T may be possible if the mean transmittance Tₘ is reduced. In FIG. 3 the mean transmittance Tₘ in the indicated range of angles of incidence is close to 99%.

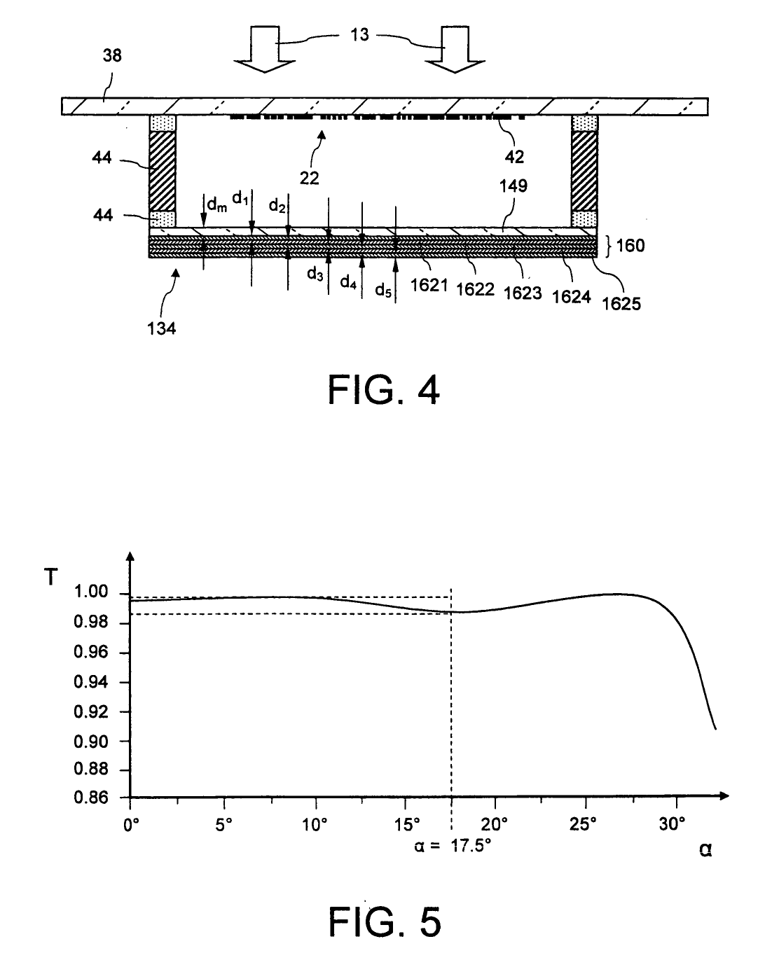

FIG. 4 shows an alternative embodiment of a pellicle in a representation similar to FIG. 2. In this embodiment a pellicle 134 comprises a membrane 149 on which an anti-reflective coating 160 is deposited. The anti-reflective coating is shown not to scale and comprises, in the embodiment shown, five layers i=1, 2, . . . , 5 that are denoted in FIG. 4 by 1621 to 1625. The layer thicknesses are indicated in FIG. 4 by d₁ to d₅. Table 1 lists the thicknesses dᵢ of the layers i=1, 2, . . . , 5, their refractive indices nᵢ and suitable materials that may be used for the particular layer i.

TABLE 1
Embodiment with four layers on one side of the membrane

| Layer No. | Thickness dᵢ | | |
|---|---|---|---|
| i | [nm] | nᵢ | Suitable materials |
| membrane | 464.29 | 1.39 | Teflon AF, Cytop |
| 1 | 31.75 | 1.70 | LaF₃, NdF₃, GdF₃ |
| 2 | 32.17 | 1.35 | Chiolith, Kryolith, |
| | | | WR3 |
| 3 | 62.46 | 1.70 | LaF₃, NdF₃, GdF₃ |
| 4 | 60.58 | 1.60 | SiO₂ |
| 5 | 65.90 | 1.38 | Teflon AF, Cytop, |
| | | | WR1, WR3, AlF₃, MgF₂, |
| | | | Chiolith, Kryolith |

FIG. 5 is a graph showing the transmittance T of the pellicle 134 in a representation similar to the graph of FIG. 3. When comparing both graphs, it can be seen that the provision of the anti-reflective coating 160 further diminishes the variations of the transmittance T to a value of less than 0.5% in a range of angles of incident between 0° and 17.5°. The provision of the anti-reflective coating 160 with the specification indicated in Table 1 has further the advantageous effect that the sharp drop of the transmittance T for angles of incidence beyond about 17.5° is suppressed. As a result, the pellicle 134 may also be used with projection lenses 20 having a still higher numerical aperture, for example NAᵢ=1.4 or even 1.6. In the latter case the maximum angle of incidence αₘₐₓ will be about 23.6° for a magnification M=¼.

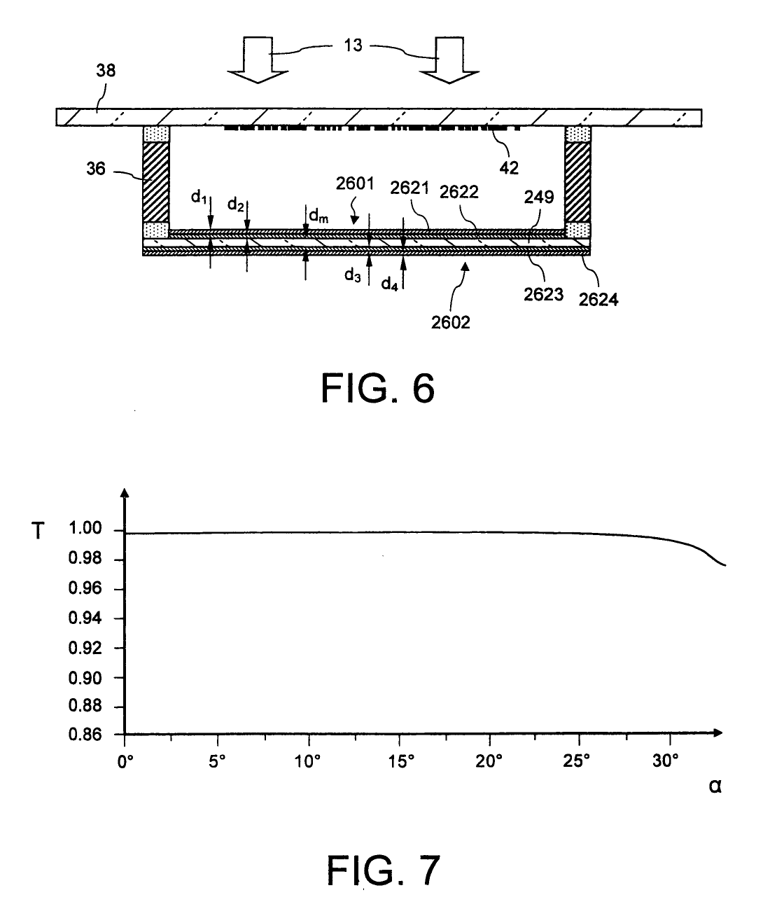

FIG. 6 shows a further embodiment in which a pellicle 234 comprises a membrane 249 having a thickness dₘ and anti-reflective coatings 2601, 2602 that are applied to opposite surfaces the membrane 249. To be more specific, two layers 2621, 2622 having thicknesses d₁, d₂, respectively, are applied to the upper surface of the membrane 249, and two layers 2623, 2324 having thicknesses d₃, d₄ are applied to the bottom surface of the membrane 249. The specification of the pellicle 234 is given below in Table 2.

TABLE 2
Four layers (distributed on both sides of the membrane)

| Layer No. | Thickness dᵢ | | |
|---|---|---|---|
| i | [nm] | n | Suitable materials |
| 1 | 42.05 | 1.39 | Teflon AF, Cytop, |
| | | | AlF₃, Chiolith, |
| | | | Kryolith |
| 2 | 18.79 | 1.70 | LaF₃, NdF₃, GdF₃ |
| membrane | 944.31 | 1.39 | Teflon AF, Cytop |
| 4 | 16.14 | 1.80 | Al₂O₃ |
| 5 | 41.90 | 1.45 | WR1, MgF₂ |

FIG. 7 is a graph showing the angular dependence of the transmittance T in a representation similar to the graphs shown in FIGS. 3 and 5. When comparing FIGS. 5 and 7, it becomes clear that the provision of anti-reflective coatings 2601, 2602 on both sides of the membrane 249 may still further reduce transmittance variations. The result is an almost perfectly flat angular transmittance distribution with T(α)≈99.9% that drops only beyond an angle of incidence of about 28°. Thus the pellicle 234 is particularly suitable for very high NA projection lenses in which even minute variations of the transmittance T cannot be tolerated. Since the deposition of the layers 2621 to 2624 on both surfaces of the membrane requires a more complicated manufacturing process, the pellicle 234 is a superior but more costly alternative to the pellicles 34 or 134 shown in FIGS. 2 and 4, respectively.

The transmittance properties of the pellicles described above may also be obtained with different material and thicknesses specifications. With the support of commercially available software it is possible to determine various other specifications that achieve a similar result. The choice for a particular design may then also be influenced by considerations relating to the manufacturing process.

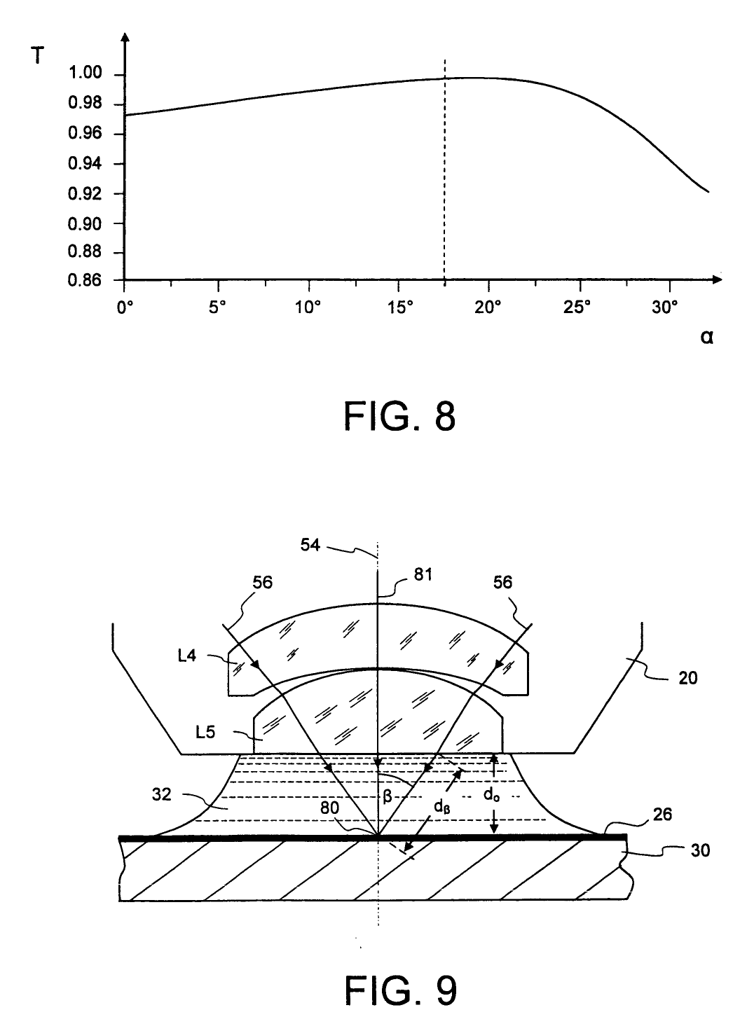

FIG. 8 is a graph showing the angular dependence of the transmittance T for another embodiment that differs from the embodiment shown in FIG. 2 only with respect to the thickness dₘ of the membrane 49. Here the thickness dₘ is determined such that the transmittance maximum Tₘₐₓ is obtained outside the possible range of angles of incidence α. As a result, the transmittance T is a monotonically increasing function of the angle of incidence α between α=0° and αₘₐₓ=17.5°. Such a pellicle is suitable for achieving an at least partial compensation of imaging defects that are caused by the absorption of the immersion liquid 32.

This will now be explained with reference to FIG. 9 which shows an enlarged end portion of the projection lens 20. For the sake of clarity, the illustration of FIG. 9 is not to scale. This particularly implies that the relative dimensions of the elements and members shown may not be correct.

The last lens L5 of the projection lens 20 is immersed in the immersion liquid 32 covering the photoresist 26. From FIG. 9 it becomes clear that light rays 56 obliquely impinging on an image point 80 on the photoresist 26 travel a distance d_{β} in the immersion liquid 32 that is greater than the distance d₀ passed by a light ray 81 that perpendicularly impinges on the image point 80. On the assumption that the absorption coefficient k of the immersion liquid 32 is homogeneous and isotropic, the oblique rays 56 are more strongly attenuated in the immersion liquid 32 due to the longer distance d_{β} traveled in the immersion liquid 32. This, in turn, results in a reduced contrast of the image produced on the photoresist 26. Since the object plane 24 and the image plane 28 are conjugated field planes, there is a direct relationship between the angle of incidence α at the pellicle on the one hand and the angle of incidence β at the photoresist 26 on the other hand. Thus an aperture ray having the maximum angle of incidence αₘₐₓ suffers minimum attenuation in the pellicle and maximum attenuation in the immersion liquid, whereas a light ray 81 traversing perpendicularly the pellicle suffers the strongest attenuation in the pellicle, but the least attenuation in the immersion liquid 32. By carefully determining the dependence of the transmittance T on the angle of incidence it is possible to achieve a substantial or even a complete compensation in the sense that the overall attenuation suffered in the pellicle and the immersion liquid is independent of the angle of incidence.

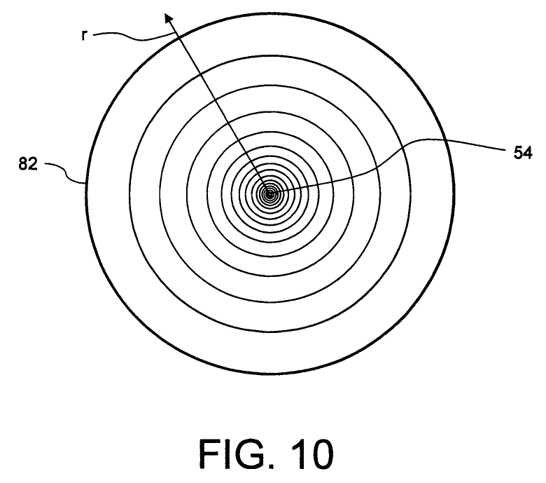

Generally, however, it will be difficult to achieve a complete compensation in a strict sense. If a significant residual angular dependency of the attenuation remains, it may be considered to introduce a gray filter 82 in a pupil plane 84 of the projection lens 20, as is shown in FIG. 1. To this end the gray filter 82 may be received in an exchange holder 86 so that it may be replaced by another gray filter having different filter characteristics. Since angles in a field plane translate into locations in a pupil plane and vice versa, the gray filter 82 may have a locally varying transmittance that is determined such that the residual angular dependency of the attenuation is completely compensated for. For example, if the transmittance T of the pellicle increases too strongly with growing angles of incidence, the transmittance filter 82 may be designed such that it has a reversed filter characteristics, i.e. a transmittance that decreases with growing distance r from the optical axis 54. FIG. 10 shows a top view of a gray filter according to this layout. The density of the circles is proportional to the transmittance of the gray filter 82.

A gray filter may also be advantageous if the projection lens 20 is not designed for immersion operation, or the immersion liquid 32 has such a small absorption that it does not introduce a significant angular dependence of the attenuation. In such a case the filter 82 may be designed such that transmittance variations of the pellicle, as are shown in the graph of FIGS. 3 and 5, are completely compensated for.

1-24. (canceled)

25. A pellicle, comprising:
a membrane; and
an anti-reflective coating applied to the membrane,
wherein the membrane and the anti-reflective coating are designed such that, for an operating wavelength of the microlithographic exposure apparatus, the transmittance of the pellicle varies by less than 2% for angles of incidence between 0° and 15°, and where the pellicle is designed to be in a microlithographic exposure apparatus.

26. The pellicle of claim 25, wherein the transmittance of the pellicle varies by less than 2% for angles of incidence between 0° and 25°.

27. The pellicle of claim 26, wherein the transmittance of the pellicle varies by less than 1% for angles of incidence between 0° and 25°.

28. An apparatus, comprising:
a) an illumination system configured to produce projection light,
b) a projection lens configured to image a pattern contained in a mask onto a light sensitive layer, and
c) a pellicle that has, for the projection light, a transmittance maximum for light rays that impinge on the pellicle with angles of incidence between 2° and the maximum angle of incidence with respect to the pellicle that may occur during operation of the apparatus,
wherein the apparatus is a microlithographic projection exposure apparatus.

29. The apparatus of claim 28, wherein the transmittance maximum is a global or a local maximum.

30. The apparatus of claim 28, wherein the pellicle has a mean transmittance that is greater than 95%, wherein the mean is taken over all angles of incidence with respect to the pellicle that may occur during operation of the apparatus.

31. The apparatus of claim 30, wherein the mean transmittance is greater than 98%.

32. The apparatus of claim 28, wherein the pellicle has a transmittance that varies by less than 5% over all angles of incidence with respect to the pellicle that may occur during operation of the apparatus.

33. The apparatus of claim 32, wherein the transmittance varies by less than 2.5%.

34. The apparatus of claim 28, wherein angles of incidence between 0° and arcsin(NAₒ) occur during operation of the apparatus, wherein NAₒ is the object side numerical aperture of the projection lens.

35. (canceled)

36. (canceled)

37. The apparatus of claim 28, wherein angles of incidence between 0° and 25° occur during operation of the projection exposure apparatus.

38. (canceled)

39. The apparatus of claim 28, wherein the pellicle comprises a membrane that is not covered by an anti-reflection coating.

40. The apparatus of claim 28, wherein the pellicle comprises a membrane and an anti-reflective coating applied to the membrane.

41. The apparatus of claim 40, wherein the anti-reflective coating is designed such that the transmittance maximum is achieved for different operating wavelengths.

42. The apparatus of claim 28, wherein the projection lens is designed for immersion operation in which an immersion liquid covers the photosensitive layer.

43. The apparatus of claim 28, wherein the transmittance of the pellicle continuously increases with growing angle of incidence until a transmittance maximum is reached.

44. The apparatus of claim 43, wherein the projection lens is designed for immersion operation in which an immersion liquid covers the photosensitive layer, and wherein the transmittance increases in such a way that an absorption of oblique rays in the immersion liquid is at least substantially compensated for.

45. The apparatus of claim 28, comprising an absorptive filter element that is arranged in or in close proximity of a pupil plane of the projection lens, the filter element having a locally varying transmittance that is determined such that the dependency of the transmittance of the pellicle on the angle of incidence is at least substantially compensated for.

46. The apparatus of claim 45, wherein the locally varying transmittance is determined such that additionally the dependency of the transmittance of the immersion liquid on a second angle of incidence with respect to the light sensitive layer is at least substantially compensated for.

47. The apparatus of claim 28, comprising an absorptive filter element that is arranged in or in close proximity of a field plane of the projection lens, the filter element having an angularly varying transmittance that is determined such that the dependency of the transmittance of the pellicle on the angle of incidence is at least substantially compensated for.

48. The apparatus of claim 47, wherein the angularly varying transmittance is determined such that additionally the dependency of the transmittance of the immersion liquid on a second angle of incidence with respect to the light sensitive layer is at least substantially compensated for.

49. The apparatus of claim 48, wherein the filter element is interchangeably arranged in a filter holder.

50. The apparatus of claim 49, wherein the projection lens has an image side numerical aperture NAᵢ>1.

51. (canceled)

52. An apparatus, comprising:
a) an illumination system configured to produce projection light,
b) a projection lens configured to image a pattern contained in a mask onto a light sensitive layer, and
c) a pellicle having a transmittance distribution such that a dependency of the transmittance of an immersion liquid on an angle of incidence with respect to the light sensitive layer is at least substantially compensated for,
wherein the apparatus is a microlithographic exposure apparatus.

53. (canceled)

54. (canceled)
